(19) United States
(12) Patent Application Publication
(10) Pub. No.: US 2014/0067366 A1
(43) Pub. Date: Mar. 6, 2014

(54) TECHNIQUES FOR SELECTING LANGUAGES FOR AUTOMATIC SPEECH RECOGNITION

(71) Applicant: Google Inc., Mountain View, CA (US)

(72) Inventors: Martin Jansche, New York, NY (US); Kaisuke Nakajima, San Jose, CA (US); Yun - hsuan Sung, Mountain View, CA (US)

(21) Appl. No.: 13/912,255

(22) Filed: Jun. 7, 2013

Related U.S. Application Data
(60) Provisional application No. 61/694,936, filed on Aug. 30, 2012.

(51) Int. Cl. G10L 15/00

(52) U.S. Cl. CPC G10L 15/005
USPC 704/8

(57) ABSTRACT

A computer-implemented technique includes receiving, at a computing device including one or more processors, a touch input from a user. The touch input includes (i) a spot input indicating a request to provide a speech input to the computing device followed by (ii) a slide input indicating a desired language for automatic speech recognition of the speech input. The technique includes receiving, at the computing device, the speech input from the user. The technique includes obtaining, at the computing device, one or more recognized characters resulting from automatic speech recognition of the speech input using the desired language. The technique also includes outputting, at the computing device, the one or more recognized characters.

### CROSS-REFERENCE TO RELATED APPLICATIONS

This application claims the benefit of U.S. Provisional Application No. 61/694,936, filed on Aug. 30, 2012. The entire disclosure of the above application is incorporated herein by reference.

### FIELD

The present disclosure relates to automatic speech recognition and, more particularly, to techniques for selecting languages for automatic speech recognition.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Automatic speech recognition refers to the translation of spoken words into text using a computing device. Automatic speech recognition can provide for more efficient input of text by a user to a computing device compared to manual entry of text by the user to the computing device, e.g., using one or more fingers or a stylus. For example, the computing device may be a mobile phone and the user may provide speech input that is captured and automatically translated into text, such as for an e-mail or a text message.

### SUMMARY

A computer-implemented technique is presented. The technique can include receiving, at a computing device including one or more processors, a touch input from a user, the touch input including (i) a spot input indicating a request to provide a speech input to the computing device followed by (ii) a slide input indicating a desired language for automatic speech recognition of the speech input. The technique can include receiving, at the computing device, the speech input from the user. The technique can include obtaining, at the computing device, one or more recognized characters resulting from automatic speech recognition of the speech input using the desired language. The technique can also include outputting, at the computing device, the one or more recognized characters.

In some embodiments, the technique further includes determining, at the computing device, a direction of the slide input from the spot input, and determining, at the computing device, the desired language based on the direction and predetermined directions associated with one or more languages for selection by the user.

In other embodiments, each of the one or more languages is associated with a predetermined range of directions, and determining the desired language includes selecting one of the one or more languages having an associated predetermined range of directions that includes the direction of the slide input from the spot input.

In some embodiments, the desired language is determined after the slide input is greater than a predetermined distance from the spot input.

In other embodiments, the technique further includes: determining, at the computing device, the predetermined directions by receiving, at the computing device, a first input from the user indicating a specific direction for each of the one or more languages for selection by the user, receiving, at the computing device, a second input from the user indicating the one or more languages for selection by the user, and automatically determining, at the computing device, the one or more languages for selection by the user based on past computing activity of the user.

In some embodiments, the technique further includes outputting, at the computing device, a user interface in response to receiving the spot input, the user interface providing the one or more languages for selection by the user.

In other embodiments, the user interface is output a predetermined delay period after receiving the spot input, the predetermined delay period being configured to allow the user to provide the slide input in one of the predetermined directions.

In some embodiments, the slide input received from the user is provided with respect to the user interface, and the user interface is a pop-up window that includes the one or more languages.

In other embodiments, the technique further includes outputting, at the computing device, a user interface in response to receiving the spot input, the user interface providing one or more languages for selection by the user.

In some embodiments, the technique further includes receiving, at the computing device, an input from the user indicating the one or more languages to be provided by the user interface, wherein the slide input received from the user is provided with respect to the user interface, and wherein the user interface is output in response to receiving the spot input, and wherein the user interface is a pop-up window that includes the one or more languages.

A computing device is also presented. The computing device can include a touch display, a microphone, and one or more processors. The touch display can be configured to receive a touch input from a user, the touch input including (i) a spot input indicating a request to provide a speech input to the computing device followed by (ii) a slide input indicating a desired language for automatic speech recognition of the speech input. The microphone can be configured to receive the speech input from the user. The one or more processors can be configured to obtain one or more recognized characters resulting from automatic speech recognition of the speech input using the desired language. The touch display can also be configured to output the one or more recognized characters.

In some embodiments, the one or more processors are further configured to: determine a direction of the slide input from the spot input, and determine the desired language based on the direction and predetermined directions associated with one or more languages for selection by the user.

In other embodiments, each of the one or more languages is associated with a predetermined range of directions, and the one or more processors are configured to determine the desired language by selecting one of the one or more languages having an associated predetermined range of directions that includes the direction of the slide input from the spot input.

In some embodiments, the desired language is determined after the slide input is greater than a predetermined distance from the spot input.

In other embodiments, the touch display is further configured to: determine the predetermined directions by receiving a first input from the user indicating a specific direction for each of the one or more languages for selection by the user, receive a second input from the user indicating the one or more languages for selection by the user, and automatically determine the one or more languages for selection by the user based on past computing activity of the user.

In some embodiments, the touch display is further configured to output a user interface in response to receiving the spot input, the user interface providing the one or more languages for selection by the user.

In other embodiments, the user interface is output a predetermined delay period after receiving the spot input, the predetermined delay period being configured to allow the user to provide the slide input in one of the predetermined directions.

In some embodiments, the slide input received from the user is provided with respect to the user interface, and the user interface is a pop-up window that includes the one or more languages.

In other embodiments, the touch display is further configured to output a user interface in response to receiving the spot input, the user interface providing one or more languages for selection by the user.

In some embodiments, the touch display is further configured to receive an input from the user indicating the one or more languages to be provided by the user interface, wherein the slide input received from the user is provided with respect to the user interface, and wherein the user interface is output in response to receiving the spot input, and wherein the user interface is a pop-up window that includes the one or more languages.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an illustration of user interaction with an example computing device according to some implementations of the present disclosure;

FIG. 2 is a functional block diagram of the example computing device of FIG. 1 including an example speech recognition control module according to some implementations of the present disclosure;

FIG. 3 is a functional block diagram of the example speech recognition control module of FIG. 2;

FIGS. 4A-4B are diagrams of example user interfaces according to some implementations of the present disclosure; and

FIG. 5 is a flow diagram of an example technique for selecting languages for automatic speech recognition according to some implementations of the present disclosure.

### DETAILED DESCRIPTION

A computing device, e.g., a mobile phone, may include an automatic speech recognition system. A user of the computing device may be capable of speaking a plurality of different languages. The automatic speech recognition system, however, may only recognize speech of a single language at a given time. The computing device, therefore, may allow the user to select a desired language for automatic speech recognition. For example, the user may have to search through settings for the automatic speech recognition system in order to select the desired language. This process can be time consuming, particularly when the user desires to provide speech input in multiple different languages during a short period of time, e.g., while speaking a single sentence, or two or more speech inputs in different languages in quick succession.

Accordingly, techniques are presented for selecting languages for automatic speech recognition. The techniques generally provide for more efficient user selection of a desired language for automatic speech recognition, which can improve the user's efficiency and/or their overall experience. The techniques can receive, at a computing device including one or more processors, a touch input from a user. The touch input can include (i) a spot input indicating a request to provide a speech input to the computing device followed by (ii) a slide input indicating a desired language for automatic speech recognition of the speech input. It should be appreciated that the touch input can alternatively include the spot input followed by one or more additional spot inputs indicating the desired language for automatic speech recognition of the speech input. The techniques can receive, at the computing device, the speech input from the user.

The techniques can obtain, at the computing device, one or more recognized characters resulting from automatic speech recognition of the speech input using the desired language. In some implementations, the automatic speech recognition can be performed by the computing device. It should be appreciated, however, that the automatic speech recognition can also be performed wholly or partially at a remote computing device, e.g., a server. For example, the computing device can transmit the speech input and the desired language to a remote server via a network, and the computing device can then receive the one or more recognized characters from the remote server via the network. The techniques can also output, at the computing device, the one or more recognized characters.

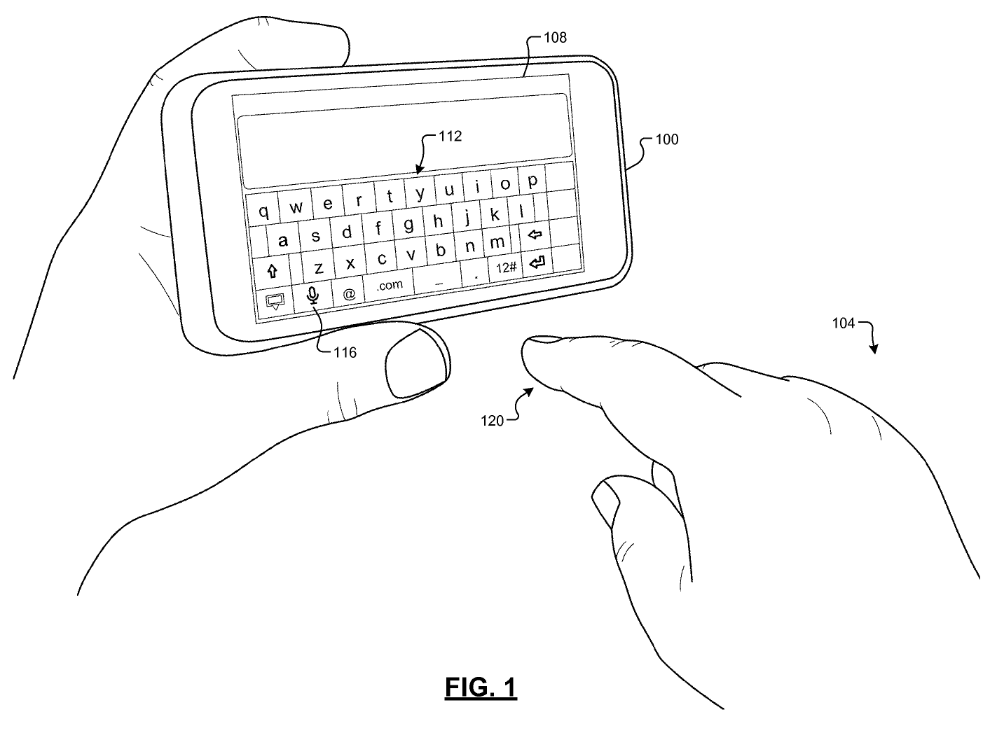

Referring now to FIG. 1, user interaction with an example computing device 100 is illustrated. While a mobile phone is illustrated, it should be appreciated that the term “computing device” as used herein can refer to any suitable computing device including one or more processors (a desktop computer, a laptop computer, a tablet computer, etc.). As shown, a user 104 can interact with a touch display 108 of the computing device 100. The touch display 108 can be configured to receive information from and/or output information to the user 104. While the touch display 108 is illustrated and described herein, it should be appreciated that other suitable user interfaces configured to receive and/or output information may be implemented, e.g., a physical keyboard. The touch display 108 can output a user interface 112. The user 104 can view the user interface 112 and can provide input via the touch display 108 with respect to the user interface 112.

As shown, the user interface 112 can include a virtual keyboard. The virtual keyboard can include a portion 116 that can be selected to enable automatic speech recognition. For example, the portion 116 may be a microphone key or button of the virtual keyboard. The user 104 can select the portion 116 of the user interface 112 by providing a spot input at the location of portion 116 with respect to the touch display 108. The term “spot input” as used herein can refer to a single touch input at a location of the touch display 108. This single touch input may be received as a “spot” instead of a single point due to the use of a finger 120 of the user 104. In contrast, the term “slide input” as used herein can refer to a sliding touch input from a location of a spot input to another location at the touch display 108. Generally, after selection of the portion 116 to enable automatic speech recognition, the user 104 can then provide speech input, which can be received by the computing device 100 via a microphone (not shown).

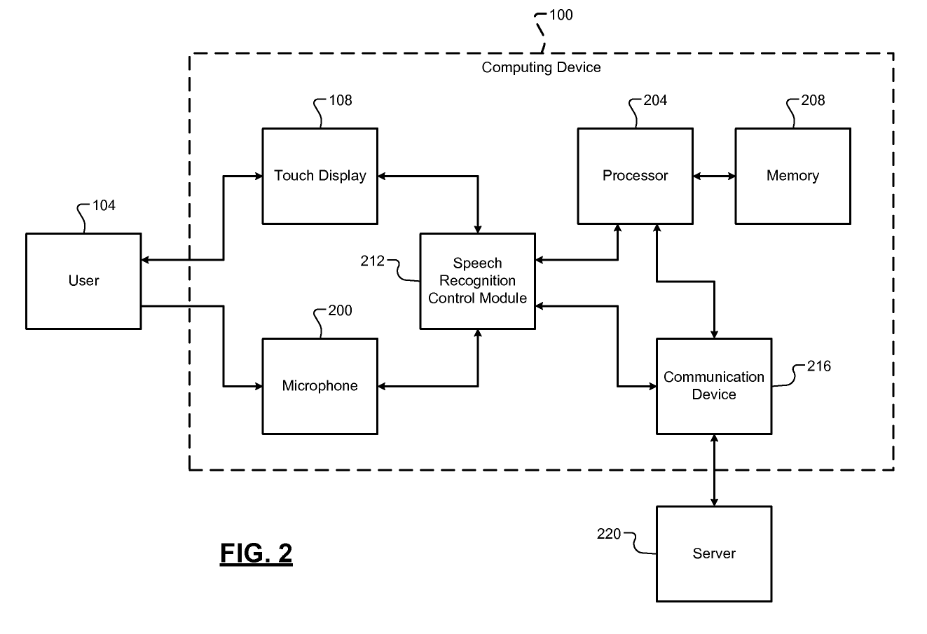

Referring now to FIG. 2, a functional block diagram of the example computing device 100 is illustrated. The computing device 100 can include the touch display 108, a microphone 200, a processor 204, a memory 208, a speech recognition control module 212, and a communication device 216. It should be appreciated that the term “processor” as used herein can refer to two or more processors operating in a parallel or distributed architecture. The processor 204 can also wholly or partially execute the speech recognition control module 212. Further, while only the microphone 200 is shown, it should be appreciated that the computing device 100 can include other suitable components for capturing and/or filtering speech input from the user 104.

The microphone 200 can be configured to receive audio information. Specifically, the microphone 200 can receive speech input from the user 104. The microphone 200 can be any suitable acoustic-to-electric microphone (an electromagnetic or dynamic microphone, a capacitance or condenser microphone, etc.) that converts the speech input into an electric signal that can be used by the computing device 100. It should be appreciated that while the microphone 200 is shown to be integrated as part of the computing device 100, the microphone 200 can also be a peripheral device that is connected to the computing device 100 via a suitable communication cable, e.g., a universal serial bus (USB) cable, or via a wireless communication channel.

The processor 204 can control operation of the computing device 100. The processor 204 can perform functions including, but not limited to, loading and executing an operating system of the computing device 100, processing information received from and/or controlling information output via the touch display 108, processing information received via the microphone 200, controlling storage/retrieval operations at the memory 208, and/or controlling communication, e.g., with a server 220, via the communication device 216. As previously mentioned, the processor 204 can also wholly or partially execute the techniques of the present disclosure, e.g., via the speech recognition control module 212. The memory 208 can be any suitable storage medium (flash, hard disk, etc.) configured to store information at the computing device 100.

The speech recognition control module 212 can control automatic speech recognition by the computing device 100. When automatic speech recognition is enabled, the speech recognition control module 212 can convert speech input that is captured by the microphone 200 into one or more recognized characters. The speech recognition control module 212 can receive control parameters from the user 104 via the touch display 108 and/or can retrieve control parameters from the memory 208. For example, the control parameters can include a desired language for performing the automatic speech recognition (at the computing device 100 or at the server 220, which is described below). The speech recognition control module 212 can also execute the techniques of the present disclosure (described in detail below).

It should be appreciated that the speech recognition control module 212 can also obtain the one or more recognized characters from the server 220, which is located remotely from the computing device 100, e.g., on a network (not shown), using the communication device 216. The communication device 216 can include any suitable components for communicating between the computing device 100 and the server 220. For example, the communication device 216 may include a transceiver for communicating via the network (a local area network (LAN), a wide area network (WAN), e.g., the Internet, a combination thereof, etc.). More specifically, the server 220 can perform the automatic speech recognition of the speech input using the desired language to obtain the one or more recognized characters, and can then provide the one or more recognized characters to the computing device 100. For example, the computing device 100 can transmit the speech input and the desired language to the server 220 along with a request to perform automatic speech recognition, and the computing device 100 can then receive the one or more recognized characters in response.

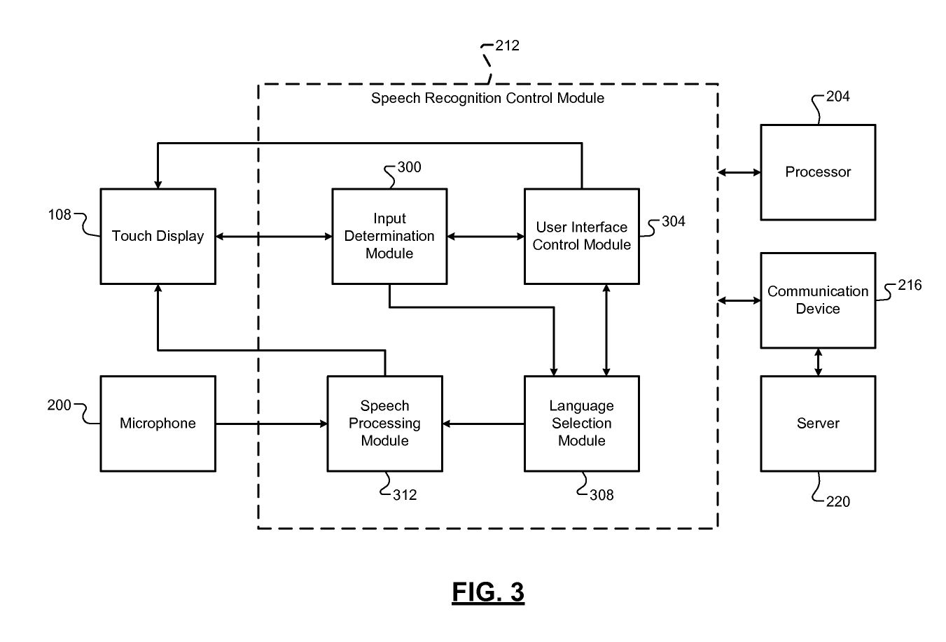

Referring now to FIG. 3, a functional block diagram of the example speech recognition control module 212 is illustrated. The speech recognition control module 212 can include an input determination module 300, a user interface control module 304, a language selection module 308, and a speech processing module 312. As previously mentioned, the processor 204 can wholly or partially execute the speech recognition control module 212 and its sub-modules.

The input determination module 300 can determine input to the computing device 100, e.g., by the user 104, via the touch display 108. The input determination module 300 can initially determine whether a spot input indicating a request to provide a speech input to the computing device 100 has been received via the touch display 108. For example, the spot input can be at the portion 116 of the user interface 112 (see FIG. 1). When the request to provide the speech input has been received, the input determination module 300 can notify the user interface control module 304.

In some implementations, the user 104 can provide input via the touch display 108 to set various parameters for automatic speech recognition. These parameters can include, but are not limited to a plurality of languages capable of being selected, ranges of directions and/or distances for slide input associated with each of the plurality of languages, and time until a pop-up window appears. (described in detail below). Some of these parameters, however, may be determined automatically. For example only, the plurality of languages capable of being selected can be automatically determined based on past computing activity by the user 104 at the computing device 100.

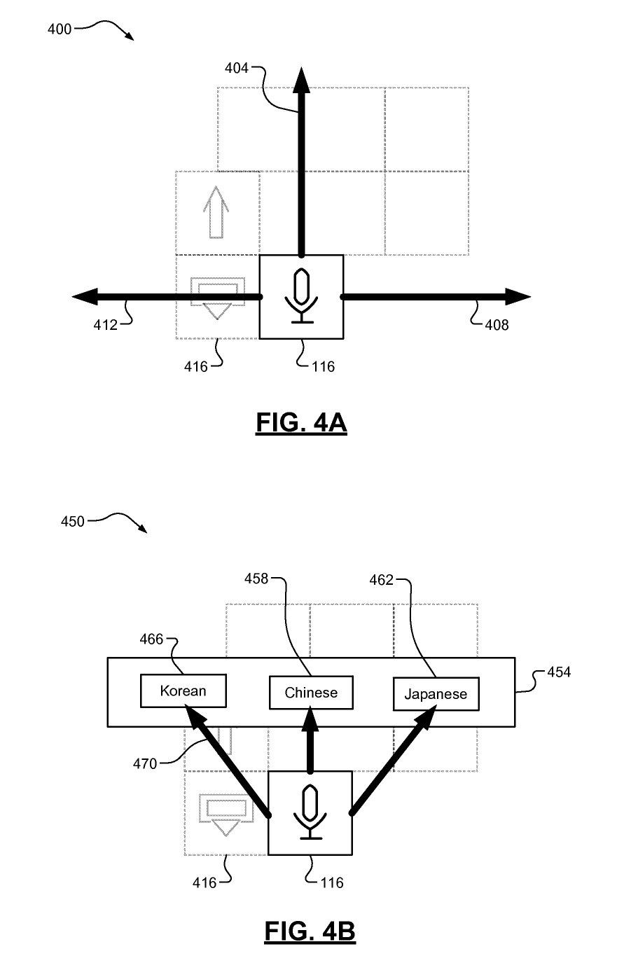

Depending on the implementation and the various parameters, the user interface control module 304 may then adjust the user interface displayed at the touch display 108 (see FIGS. 4A-4B). For example only, the user interface control module 304 may provide a pop-up window at the touch display 108 for the user 104 to select a language for automatic speech recognition. The input determination module 300, therefore, can then determine what additional input is received, e.g., from the user 104, at the touch display 108. Again, depending upon the configuration provided by the user interface control module 304, the additional input can include slide input following the spot input or additional spot input, e.g., at the pop-up window. The input determination module 300 can then notify the language selection module 308 of the additional input that was received.

The language selection module 308 can then select one of a plurality of languages to be used for automatic speech recognition based on the additional input received. The language selection module 308 may communicate with the user interface control module 304 in determining which language is associated with the additional input. The language selection module 308 can then notify the speech processing module 312 of the selected language. The speech processing module 312 can then enable the microphone 200 to receive the requested speech input. For example, the speech processing module 312 can also provide a notification to the user 104 via the touch display 108 in order to begin receiving the speech input.

The microphone 200 can capture the speech input, e.g., from the user 104, and communicate the speech input to the speech processing module 312. The speech processing module 312 can then perform automatic speech recognition of the speech input based on the selected language to obtain one or more recognized characters. The speech processing module 312 can use any suitable automatic speech recognition processing techniques. For example, as previously discussed, the speech processing module 312 can obtain the one or more recognized characters from the server 220 using the communication device 216, with the server 220 having performed the automatic speech recognition of the speech input using the desired language to obtain the one or more recognized characters. The speech processing module 312 can then output the one or more recognized characters to the touch display 108. For example, the user 104 can then use the one or more recognized characters to perform various tasks at the computing device 100 (text messaging, e-mailing, web browsing, etc.).

Referring now to FIGS. 4A-4B, example user interfaces 400 and 450 are illustrated. For example, the user interfaces 400 and/or 450 can be displayed to the user 104 as the user interface 112 at the touch display 108 (see FIG. 1). The user 104 can then provide input with respect to the user interfaces 400 and/or 450 at the touch display 108 to select the desired language for automatic speech recognition. It should be appreciated that the user interfaces 400 and 450 and their corresponding languages are for illustrative and explanatory purposes and other suitable user interfaces may be implemented, e.g., with respect to a different virtual keyboard configuration.

Referring now to FIG. 4A, the example user interface 400 can include the portion 116 for activating automatic speech recognition. This portion 116 can be referred to hereinafter as the microphone icon 116 because the microphone 200 can be activated for automatic speech recognition when the user 104 selects the microphone icon 116. In this embodiment, the user 104 can provide a spot input at the microphone icon 116 and can then provide a slide input in one of a plurality of directions. Each of the plurality of directions can be associated with a different language for automatic speech recognition. It should be appreciated that while three different directions 404, 408, and 412 are shown, other numbers of directions can be implemented.

For example only, direction 404 can be associated with Chinese, direction 408 can be associated with Japanese, and direction 412 can be associated with Korean. Other suitable languages can also be implemented. It should also be appreciated that the slide input can traverse one or more other icons of the user interface 400, e.g., slide input in direction 412 traverses a keyboard icon 416. As previously described herein, in some implementations after the user 104 has provided the slide input in one of the directions 404, 408, and 412 for greater than a predetermined distance, the corresponding language may then be selected for automatic speech recognition.

The slide input provided by the user 104 via the touch display 108, however, may not be exactly in a same direction as one of the directions 404, 408, and 412. The computing device 100, therefore, can first determine a direction of the slide input from the spot input, and then compare the direction with predetermined ranges of directions associated with each of the directions 404, 408, 412. For example only, directions 404, 408, and 412 may each have a 60 degree range of directions (for an arc of a total of 180 degrees). The computing device 100 can then select one of the one or more languages having an associated predetermined range of directions that includes the direction of the slide input from the spot input.

Referring now to FIG. 4B, the other example user interface 450 can include the microphone icon 116. In this embodiment, the user 104 can provide spot input at the microphone icon 116, which causes a pop-up window 454 to appear. As shown, the pop-up window 454 may overlay the underlying virtual keyboard. It should be appreciated, however, that the pop-up window 454 could be arrange in another suitable configuration, e.g., integrated into the virtual keyboard. The pop-up window 454 can be configured to present one or more languages for automatic speech recognition for selection by the user 104. For example only, the pop-up window 454 can include a Chinese icon 458, a Japanese icon 462, and a Korean icon 466. As previously mentioned, other languages can also be implemented. The user 104 can provide a slide input from the microphone icon 116 to one of the icons 458, 462, and 466 of the pop-up window 454. As previously explained, the slide input can traverse one or more other icons of the user interface 450, e.g., slide input 470 also traverses the keyboard icon 416.

Alternatively, in some implementations the pop-up window 454 may be configured to receive another spot input at one of the icons 458, 462, and 466. Furthermore, as previously explained, in some implementations the pop-up window 454 may not appear until the user 104 has provided the spot input at the microphone icon 116 for greater than a predetermined period. In other words, the appearance of the pop-up window 454 may be delayed, e.g., to allow the user 104 a period in order to provide the slide input with respect to the user interface 400 of FIG. 4A. This feature may be implemented because the language selection configuration according to the user interface 400 of FIG. 4A may be faster than the language selection configuration according to the user interface 450 of FIG. 4B, and therefore the pop-up window 454 may be implemented as a secondary or back-up language selection configuration.

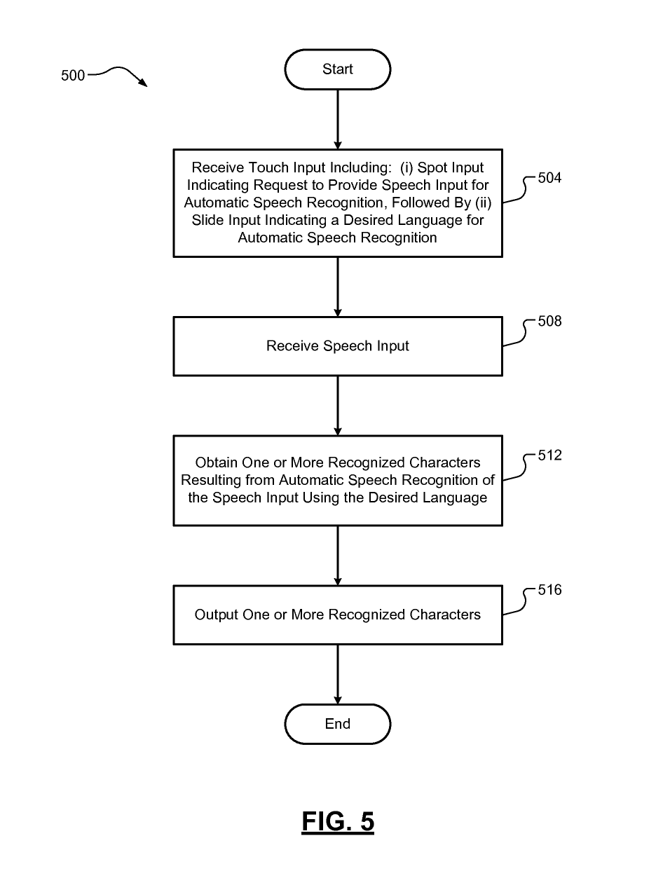

Referring now to FIG. 5, an example technique 500 for selecting languages for automatic speech recognition is illustrated. At 504, the computing device 100 can receive a touch input from the user 104. The touch input can include (i) a spot input indicating a request to provide a speech input to the computing device followed by (ii) a slide input indicating a desired language for automatic speech recognition of the speech input. At 508, the computing device 100 can receive the speech input from the user 104. At 512, the computing device 100 can obtain one or more recognized characters resulting from automatic speech recognition of the speech input using the desired language. At 516, the computing device 100 can output the one or more recognized characters. The technique 500 can then end or return to 504 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device including one or more processors, a touch input from a user, the touch input including (i) a spot input indicating a request to provide a speech input to the computing device followed by (ii) a slide input indicating a desired language for automatic speech recognition of the speech input;
receiving, at the computing device, the speech input from the user;
obtaining, at the computing device, one or more recognized characters resulting from automatic speech recognition of the speech input using the desired language; and
outputting, at the computing device, the one or more recognized characters.

2. The computer-implemented method of claim 1, further comprising:
determining, at the computing device, a direction of the slide input from the spot input; and
determining, at the computing device, the desired language based on the direction and predetermined directions associated with one or more languages for selection by the user.

3. The computer-implemented method of claim 2, wherein each of the one or more languages is associated with a predetermined range of directions, and wherein determining the desired language includes selecting one of the one or more languages having an associated predetermined range of directions that includes the direction of the slide input from the spot input.

4. The computer-implemented method of claim 2, wherein the desired language is determined after the slide input is greater than a predetermined distance from the spot input.

5. The computer-implemented method of claim 2, further comprising:
determining, at the computing device, the predetermined directions by receiving, at the computing device, a first input from the user indicating a specific direction for each of the one or more languages for selection by the user;
receiving, at the computing device, a second input from the user indicating the one or more languages for selection by the user; and
automatically determining, at the computing device, the one or more languages for selection by the user based on past computing activity of the user.

6. The computer-implemented method of claim 2, further comprising outputting, at the computing device, a user interface in response to receiving the spot input, the user interface providing the one or more languages for selection by the user.

7. The computer-implemented method of claim 6, wherein the user interface is output a predetermined delay period after receiving the spot input, the predetermined delay period being configured to allow the user to provide the slide input in one of the predetermined directions.

8. The computer-implemented method of claim 7, wherein the slide input received from the user is provided with respect to the user interface, and wherein the user interface is a pop-up window that includes the one or more languages.

9. The computer-implemented method of claim 1, further comprising outputting, at the computing device, a user interface in response to receiving the spot input, the user interface providing one or more languages for selection by the user.

10. The computer-implemented method of claim 9, further comprising receiving, at the computing device, an input from the user indicating the one or more languages to be provided by the user interface, wherein the slide input received from the user is provided with respect to the user interface, and wherein the user interface is output in response to receiving the spot input, and wherein the user interface is a pop-up window that includes the one or more languages.

11. A computing device, comprising:
a touch display configured to receive a touch input from a user, the touch input including (i) a spot input indicating a request to provide a speech input to the computing device followed by (ii) a slide input indicating a desired language for automatic speech recognition of the speech input;
a microphone configured to receive the speech input from the user; and
one or more processors configured to obtain one or more recognized characters resulting from automatic speech recognition of the speech input using the desired language,
wherein the touch display is further configured to output the one or more recognized characters.

12. The computing device of claim 11, wherein the one or more processors are further configured to:
determine a direction of the slide input from the spot input; and
determine the desired language based on the direction and predetermined directions associated with one or more languages for selection by the user.

13. The computing device of claim 12, wherein each of the one or more languages is associated with a predetermined range of directions, and wherein the one or more processors are configured to determine the desired language by selecting one of the one or more languages having an associated predetermined range of directions that includes the direction of the slide input from the spot input.

14. The computing device of claim 12, wherein the desired language is determined after the slide input is greater than a predetermined distance from the spot input.

15. The computing device of claim 12, wherein the touch display is further configured to:
determine the predetermined directions by receiving a first input from the user indicating a specific direction for each of the one or more languages for selection by the user;
receive a second input from the user indicating the one or more languages for selection by the user; and
automatically determine the one or more languages for selection by the user based on past computing activity of the user.

16. The computing device of claim 12, wherein the touch display is further configured to output a user interface in response to receiving the spot input, the user interface providing the one or more languages for selection by the user.

17. The computing device of claim 16, wherein the user interface is output a predetermined delay period after receiving the spot input, the predetermined delay period being configured to allow the user to provide the slide input in one of the predetermined directions.

18. The computing device of claim 17, wherein the slide input received from the user is provided with respect to the user interface, and wherein the user interface is a pop-up window that includes the one or more languages.

19. The computing device of claim 11, wherein the touch display is further configured to output a user interface in response to receiving the spot input, the user interface providing one or more languages for selection by the user.

20. The computing device of claim 19, wherein the touch display is further configured to receive an input from the user indicating the one or more languages to be provided by the user interface, wherein the slide input received from the user is provided with respect to the user interface, wherein the user interface is output in response to receiving the spot input, and wherein the user interface is a pop-up window that includes the one or more languages.
